(19) United States
(12) Patent Application Publication
(10) Pub. No.: US 2011/0050525 A1
(43) Pub. Date: Mar. 3, 2011

(54) RADAR DEVICE AND ANTENNA ANGLE ADJUSTING METHOD

(75) Inventors: Hiromasa SANADA, Kobe-shi (JP); Keiichi Kidokoro, Kobe-shi (JP)

(73) Assignee: FUJITSU TEN LIMITED, KOBE-SHI (JP)

(21) Appl. No.: 12/868,176

(22) Filed: Aug. 25, 2010

(30) Foreign Application Priority Data
Aug. 26, 2009 (JP) 2009-194894
Sep. 7, 2009 (JP) 2009-205525

(51) Int. Cl. H01Q 3/06

(52) U.S. Cl. 343/760; 343/757

(57) ABSTRACT

A radar device is provided. A planar antenna is tiltably provided with respect to a housing. A detecting section detects a tilt angle of the planar antenna with respect to the gravity direction. A moving section moves the planar antenna to adjust the tilt angle of the planar antenna. A storage section stores a history of the tilt angle of the planar antenna and a tiltable range of the planar antenna with respect to the housing. The moving section moves the planar antenna by a first angle to adjust the tilt angle of the planar antenna to a reference angle if the sum of the history of the tilt angle of the planar antenna and the first angle is within the tiltable range of the planar antenna. The moving section does not move the planar antenna by the first angle if the sum of the history of the tilt angle of the planar antenna and the first angle is beyond the tillable range of the planar antenna.

The disclosures of Japanese Patent Application No. 2009-194894 filed on Aug. 26, 2009 and Japanese Patent Application No. 2009-205525 filed on Sep. 7, 2009, including specifications, drawings and claims are incorporated herein by reference in its entirety.

### BACKGROUND

The present invention relates to a technique of adjusting a beam axis (an antenna angle) of a radar device to be installed on a vehicle.

An in-vehicle radar device to be installed on a vehicle, such as an automobile, scans a space around the vehicle with a radar signal in order to detect targets, such as other vehicles, pedestrians and objects on a road, which are mainly located on the same horizontal plane as the vehicle on which the radar device is installed. In order to detect those targets with high precision, it is preferable to direct a beam axis of the radar signal toward the horizontal direction (hereinafter, referred to as a reference direction) to maximize a reception gain. Accordingly, when installing a radar device on a vehicle, an operation of making the beam axis direct toward the reference direction by adjusting the tilt angle of a housing, in which an antenna is housed, with respect to the gravity direction (hereinafter, simply referred to as a tilt angle), that is, beam axis adjustment is performed. JP-A-2000-056009 discloses such a beam axis adjustment.

In the beam axis adjustment, in consideration of the manufacture error of each radar device, the tilt angle of the housing, at which the beam axis is directed toward the reference direction, is first detected for every radar device before the radar device is installed on the vehicle. Then, when the radar device is installed on the vehicle, the posture of the housing is adjusted to have the tilt angle detected beforehand. In this case, a worker roughly positions the housing of the radar device on the vehicle placed on the horizontal plane, fixes the housing to the vehicle, and then finely adjusts the tilt angle of the housing by a manual operation while viewing a level tube attached to the housing.

A radar device is generally installed at a low and inconspicuous position of the vehicle, such as an inner side of a bumper or a front grille, in order to suppress the influence on the design of the vehicle. Thus, the worker has to bend his or her body to perform the beam axis adjustment. In addition, since the installation space of the radar device is restricted, it is difficult to adequately ensure the operation space of the beam axis adjustment. For these reasons, the working efficiency in the beam axis adjustment tends to be low. Therefore, JP-A-2010-096588 (Japanese Patent Application No. 2008-266503 filed with Japan Patent Office on Oct. 15, 2008) proposes a radar device capable of improving the working efficiency in the beam axis adjustment.

FIG. 1A is a perspective view illustrating a radar device disclosed in JP-A-2010-096588.

A radar device 10 has a planar antenna 14 and various electronic circuits which are housed in a rectangular housing 11. A radome 11a is provided in a front portion of the housing 11. In the following explanation, it is assumed that a side on which the radome 11a is provided in the housing 11 is a front side and the opposite side is a rear side.

The rear side of the housing 11 is fixed to an installation portion at a front part of the vehicle with a fixture 13 such as a bolt, in a state where the radome 11a is directed toward, for example, the front of the vehicle. In addition, the planar antenna 14 transmits a radar signal forward through the radome 11a.

FIG. 1B is a cross-sectional view illustrating the radar device 10 taken along a line A-A′ shown in FIG. 1A. One end 14a of the planar antenna 14 is attached to the housing 11 through a tilting shaft 15 so that the other end 14b of the planar antenna 14 can tilt back and forth around the tilting shaft 15. The planar antenna 14 is comprised of an array antenna, a patch antenna, or the like, and is provided in the housing 11 in a state where a surface on which an array or a patch is formed, directs toward the front. The planar antenna 14 forms a beam axis of a radar signal in a direction perpendicular to the surface.

An antenna angle detecting section 16 (for example, an acceleration sensor) which detects a tilt angle of the planar antenna 14 with respect to the gravity direction (hereinafter, referred to as an antenna angle) is provided on the back surface of the planar antenna 14. FIG. 1B shows a state where the antenna angle is 0°.

In addition, an antenna moving section 18 which moves the planar antenna 14 to adjust the antenna angle is provided in the housing II. The antenna moving section 18 includes a sliding shaft 18a whose front end is rotatably engaged with the end 14b of the planar antenna 14 and which is slidable back and forth, a motor 18b, and a deceleration mechanism 18d which decelerates the rotational motion of a shaft 18c of the motor 18b at a predetermined rate to convert the rotational motion of the shaft 18c into a sliding motion of the sliding shaft 18a. The antenna moving section 18 makes the sliding shaft 18a slide forward/backward by performing positive rotation/negative rotation of the motor 18c. If the sliding shaft 18a slides forward/backward, the end 14b of the planar antenna 14 moves forward/backward. As a result, the antenna angle of the planar antenna 14 is adjusted.

In this radar device 10, the beam axis adjustment is performed as follows when installed on a vehicle.

The beam axis adjustment of the radar device 10 will be described with reference to FIGS. 2A and 2B. FIG. 2A is a cross-sectional view illustrating the radar device 10 in a state where the housing 11 is installed on the vehicle. As shown in FIG. 2A, it is assumed that the tilt angle of the housing 11 is α° (>0°) when the housing 11 is attached to the vehicle placed on the horizontal plane. Hereinafter, for the sake of convenience, the tilt to the front side is expressed as a positive value and the tilt with respect to the rear side is expressed as a negative value.

Here, assuming that the initial antenna angle of the planar antenna 14 when the housing 11 is placed on the horizontal plane is 0°, the antenna angle when the housing 11 is installed on the vehicle is α°.

When a control signal which instructs the beam axis adjustment is input to a control unit (not shown) of the radar device 10, the control unit starts driving the antenna moving section 18 in response to the control signal. A reference antenna angle (for example, 0°), which is an antenna angle at which the beam axis directs toward the reference direction, is set beforehand in the control unit, and the antenna moving section 18 moves the planar antenna 14 to adjust the tilt angle of the planar antenna 14 from α° which is detected by the antenna angle detecting section 16 to the reference antenna angle. In this way, the beam axis adjustment is performed without manually adjusting the tilt angle of the housing 11 by the worker.

According to the above-described radar device 10, the beam axis can be adjusted when the radar device 10 is installed on the vehicle. In addition, the beam axis can be readjusted in the same manner described above at the time of vehicle checking and maintenance even if the tilt angle of the housing 11 changes due to vibration from the road surface during traveling or contact or collision with the other vehicle or an obstacle and thus the beam axis deviates from the reference direction (hereinafter, the beam axis adjustment when installing the radar device 10 on the vehicle is referred to as a first-time beam axis adjustment and the subsequent beam axis adjustment is referred to as a beam axis readjustment). In the radar device 10, however, the following problems may occur at the time of the beam axis readjustment.

FIG. 2B is a cross-sectional view illustrating the radar device 10 in a state where the tilt angle of the housing 11 changes after the first-time beam axis adjustment and the tilt angle of the housing 11 with respect to the gravity direction becomes β° (>α°). In this situation, the antenna angle of the planar antenna 14 is β°. In order to perform the beam axis readjustment to set the antenna angle to a reference antenna angle, it is necessary to move the planar antenna 14 forward to change the antenna angle by β°. However, as shown in FIG. 2B, if a distance between the planar antenna 14 and the inner wall of the radome 11a is short compared with β° by which the planar antenna 14 is to be tilted (hereinafter, referred to as a planned tilt angle), the end 14b of the planar antenna 14 comes in contact with the inner wall of the radome 11a before the planar antenna tilts forward by β° (arrow B1). As a result, the sliding shaft 18a cannot slide forward any more.

As described above, if a change in the tilt angle of the housing 11 after the first-time beam axis adjustment increases, the sliding shaft 18a may become unslidable. In this case, in the deceleration mechanism 18d of the antenna moving section 18, a worm gear attached to the motor shaft 18c may be abnormally engaged with a worm wheel to which the torque of the worm gear is transferred at the predetermined deceleration rate. Consequently, the deceleration mechanism 18d is fixed, the sliding shaft 18a cannot slide not only forward but also backward with the driving force of the motor 18b and then the antenna moving section 18 becomes unable to move the planar antenna 14. As a result, the beam axis adjustment is not appropriately performed and thus the target detection accuracy may be reduced. Moreover, since it is necessary to overhaul the radar device 10 to dissolve the abnormal engagement, it result in a cost increase and an inconvenience.

The radar device installed on the vehicle transmits a transmission wave to a target and receives a reflection wave from the target to detect the target such as the other vehicle or an object placed on the road. To detect the target, it is necessary to adjust a direction of the beam axis of the radar device such that an intensity of the reflection wave becomes a predetermined value or more. Since the beam axis of the radar device is directed perpendicular to an antenna surface of the antenna, an antenna angle (an angle of the antenna) is adjusted to adjust the direction of the beam axis.

Here, since the installation of the radar device on the vehicle is performed in a limited space in the vehicle, which is different according to a type of the vehicle, it depends on the installation position of the radar device or the skill of a worker who perform the installation to realize a desired antenna angle at which the intensity of the reflection wave becomes equal to or larger than the predetermined value.

For this reason, the antenna angle for achieving a desired beam axis direction is calculated in advance, the calculated antenna angle is stored in a storage device of the radar device as a target angle, and an automatic adjustment to the target angle is performed using a tilt sensor and a motor.

JP-A-2004-156948 discloses that a light receiving lens and its lens holder are swingably held in an object detector for a movable body and the lens holder is fixed to perform an axis adjustment after a predetermined time elapses and the swing stops.

JP-A-10-132920 discloses monitoring a deviation amount of an attachment angle of a radar head to a vehicle from the reference value and notifying the driver that the deviation amount becomes a predetermined value or more.

However, in the case where the antenna angle adjustment is performed in a vehicle factory, a dealer, or the like, vibration caused by contact with a vehicle, such as opening and closing of a vehicle door or getting on and off the vehicle by a worker, at the time of the antenna angle adjustment after attaching the radar device to the vehicle, may be applied to the vehicle. As a result, since the output of the tilt sensor which detects the antenna angle is changed, the antenna angle may not be accurately adjusted.

The process disclosed in JP-A-2004-156948 is performed after simply waiting until the swing of the light receiving lens stops in the process of adjusting the beam axis. The process disclosed in JP-A-10-132920 is performed when the angle deviation with respect to a predetermined antenna angle occurs. Neither the process disclosed in JP-A-2004-156948 nor the process disclosed in JP-A-10-132920 detects an error of the antenna angle during adjusting the antenna angle.

### SUMMARY

It is therefore a first object of at least one embodiment of the present invention to provide a radar device capable of avoiding a situation where a planar antenna becomes unable to move when performing the beam axis adjustment.

A second object of at least one embodiment of the present invention is to provide a technique capable of performing accurate adjustment to the target angle by preventing erroneous angle adjustment caused by the factors occurring during antenna angle adjustment.

In order to achieve at least one of the above-described objects, according to a first aspect of the embodiments of the present invention, there is provided a radar device comprising: a housing; a planar antenna tiltably provided with respect to the housing; a detecting section that detects a tilt angle of the planar antenna with respect to the gravity direction; a moving section that moves the planar antenna to adjust the tilt angle of the planar antenna; and a storage section that stores a history of the tilt angle of the planar antenna and a tiltable range of the planar antenna with respect to the housing, wherein the moving section moves the planar antenna by a first angle to adjust the tilt angle of the planar antenna to a reference angle if the sum of the history of the tilt angle of the planar antenna and the first angle is within the tiltable range of the planar antenna, and wherein the moving section does not move the planar antenna by the first angle if the sum of the history of the tilt angle of the planar antenna and the first angle is beyond the tiltable range of the planar antenna.

The history of the tilt angle may start from an initial value of a tilt angle of the planar antenna with respect to the housing. The detecting section may include an acceleration sensor provided in the planar antenna. Alternatively, the detecting section may include: a sensor provided in the housing, the sensor that detects a tilt angle of the housing with respect to the gravity direction; and a control section that detects the tilt angle of the planar antenna with respect to the gravity direction on the basis of the tilt angle of the housing and the history of the tilt angle of the planar antenna. The radar device may further comprise a control section that outputs a warning when the sum of the history of the tilt angle of the planar antenna and the first angle is beyond the tillable range of the planar antenna. The radar device may further comprise a control section that outputs a warning when the sum of the history of the tilt angle of the planar antenna and the first angle is within the tiltable range of the planar antenna and is beyond a predetermined threshold value. The moving section may include a deceleration mechanism that decelerates rotation of a motor to convert the rotation of the motor into a driving force of the planar antenna.

When the housing is mounted on a horizontal plane, the detecting section may detect an initial tilt angle of the planar antenna with respect to the gravity direction and the storage section may store the initial tilt angle. When the housing is then mounted on a vehicle, the detecting section may detect a secondary tilt angle of the planar antenna with respect to the gravity direction. If the sum of the initial tilt angle and the secondary tilt angle is within the tiltable range of the planar antenna, the moving section moves the planar antenna by the secondary tilt angle to adjust the tilt angle of the planar antenna to the reference angle and the storage section stores the secondary tilt angle. If the sum of the initial tilt angle and the secondary tilt angle is beyond the tiltable range of the planar antenna, the moving section does not move the planar antenna by the secondary tilt angle. When the housing is then moved, the detecting section may detect a tertiary tilt angle of the planar antenna with respect to the gravity direction. If the sum of the initial tilt angle, the secondary tilt angle and the tertiary tilt angle is within the tiltable range of the planar antenna, the moving section moves the planar antenna by the tertiary tilt angle to adjust the tilt angle of the planar antenna to the reference angle and the storage section stores the tertiary tilt angle. If the sum of the initial tilt angle, the secondary tilt angle and the tertiary tilt angle is beyond the tiltable range of the planar antenna, the moving section does not move the planar antenna by the tertiary tilt angle.

According to the first aspect of the embodiments of the present invention, it is possible to avoid the situation where the planar antenna becomes unable to move when performing the beam axis adjustment.

According to a second aspect of the embodiments of the present invention, there is provided a radar device comprising: a tilt angle detecting section that detects a tilt angle of an antenna with respect to a target angle; an adjusting section that adjusts an angle of the antenna from the tilt angle to the target angle; a calculating section that calculates an estimation value which is a criterion for determining whether or not an adjustment from the tilt angle to the target angle is performed as planned; a measurement value detecting section that detects a measurement value in accordance with variation in the angle of the antenna during the adjustment from the tilt angle to the target angle; and an adjustment failure detecting section that detects a failure of the adjustment on the basis of an error between the estimation value and the measurement value.

The estimation value may include estimation angles of the antenna for every predetermined time, and the measurement value may include measurement angles of the antenna for every predetermined time.

The estimation value may include an estimation time to complete the adjustment, and the measurement value may include a measurement time to complete the adjustment.

The estimation value may include estimation angles of the antenna for every predetermined time and an estimation time to complete the adjustment, the measurement value may include measurement angles of the antenna for every predetermined time and a measurement time to complete the adjustment, and the adjustment failure detecting section may detect the failure of the adjustment on the basis of an error between the estimation angles and the measurement angles for every predetermined time and an error between the estimation time and the measurement time.

The radar device may further comprise a notifying section that notifies that the error exceeds a predetermined range.

According to a second aspect of the embodiments of the present invention, there is provided a method for adjusting an angle of an antenna, comprising: detecting a tilt angle of the antenna with respect to a target angle; adjusting the angle of the antenna from the tilt angle to the target angle; calculating an estimation value which is a criterion for determining whether or not the adjusting of the angle of the antenna from the tilt angle to the target angle is performed as planned; detecting a measurement value in accordance with variation in the angle of the antenna during the adjusting of the angle of the antenna from the tilt angle to the target angle; and detecting a failure of the adjusting on the basis of an error between the estimation value and the measurement value.

According to the second and third aspects of the embodiments of the present invention, the adjustment of the angle of the antenna is performed while detecting the error between the estimation value and the measurement value in accordance with the angle variation of the antenna, it is possible to prevent the failure of the adjustment caused by factors occurring during the adjustment. As a result, accurate angle adjustment to the target angle can be performed.

In addition, it is possible to finely check the angle of the antenna for every time during the adjustment by performing the adjustment of the angle of the antenna while detecting the error between the estimation angles of the antenna and the measurement angles of the antenna. As a result, accurate angle adjustment to the target angle can be performed.

In addition, it is possible to prevent the failure of the adjustment caused by the adjustment time difference by detecting the error between the estimation time from the start of the adjustment to the completion of the adjustment and the measurement time from the start to the completion. As a result, accurate angle adjustment to the target angle can be performed.

In addition, when the error exceeds a predetermined range, an alarm is given to the worker in a vehicle factory, a dealer, or the like. As a result, since a malfunction of the radar device can be prevented in advance, safe vehicle control can be provided for the user who uses the vehicle.

### BRIEF DESCRIPTION OF THE DRAWINGS

In the accompanying drawings:

FIG. 1A is a perspective view illustrating a radar device;

FIG. 1B is a cross-sectional view illustrating the radar device shown in FIG. 1A;

FIG. 2A is a cross-sectional view illustrating the radar device shown in FIG. 1A in a state where the tilt angle of the housing is α′;

FIG. 2B is a cross-sectional view illustrating the radar device shown in FIG. 1A in a state where the tilt angle of the housing is β°;

FIG. 3 is a schematic view illustrating a radar device according to a first embodiment of the present invention in a state where the radar device is installed on a vehicle;

FIG. 4 is a cross-sectional view illustrating an internal structure of the radar device according to the first embodiment;

FIG. 5 is a block diagram illustrating a configuration of the radar device according to the first embodiment;

FIGS. 6A to 6C are schematic views each illustrating the housing for explaining the tilt angle of the housing with respect to the gravity direction;

FIGS. 6D to 6F are schematic views each illustrating the planar antenna for explaining the tilt angle of the planar antenna with respect to the gravity direction;

FIGS. 7A to 7C are schematic views each illustrating the radar device for explaining the beam axis adjustment;

FIG. 8 is a flow chart illustrating operation procedures of the radar device in a state shown in FIG. 7A;

FIG. 9 is a flow chart illustrating operation procedures of the radar device in states shown in FIGS. 7B and 7C;

FIG. 10 is a flow chart illustrating operation procedures of beam axis readjustment in a preferable embodiment;

FIG. 11 is a perspective view illustrating a radar device according to a second embodiment of the present invention;

FIG. 12 is a schematic view illustrating the radar device according to the second embodiment in a state where the radar device is installed on a vehicle;

FIG. 13 is a cross-sectional view illustrating an internal structure of the radar device according to the second embodiment;

FIG. 14 is a block diagram illustrating a configuration of the radar device according to the second embodiment;

FIG. 15 is an explanatory diagram of an angle error occurring at the time of an antenna angle adjustment;

FIG. 16 is an explanatory diagram of an adjustment time error occurring at the time of the antenna angle adjustment.

FIG. 17 is a flow chart illustrating the first antenna angle adjustment processing;

FIG. 18 is a flow chart illustrating the second antenna angle adjustment processing; and

FIG. 19 is a flow chart illustrating the third antenna angle adjustment processing.

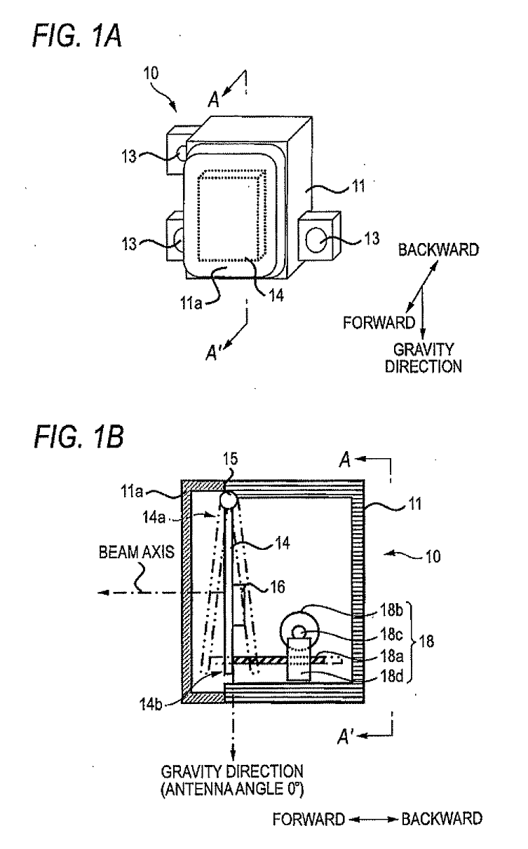

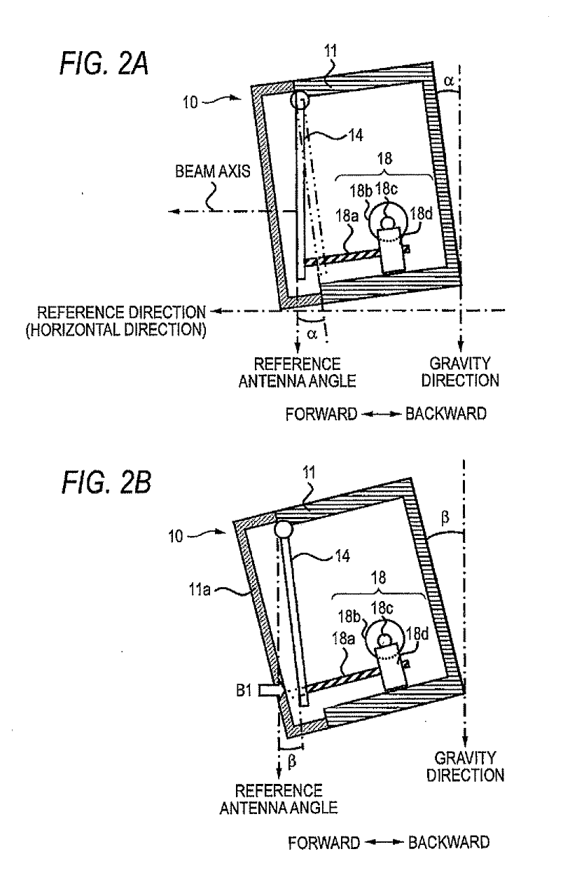

### DETAILED DESCRIPTION OF THE EMBODIMENTS

Hereinafter, embodiments of the invention will be described with reference to the accompanying drawings. However, the technical scope of the invention is not limited to these embodiments, but the subject matter defined by the appended claims and their equivalents are also included in the technical scope of the invention.

### First Embodiment

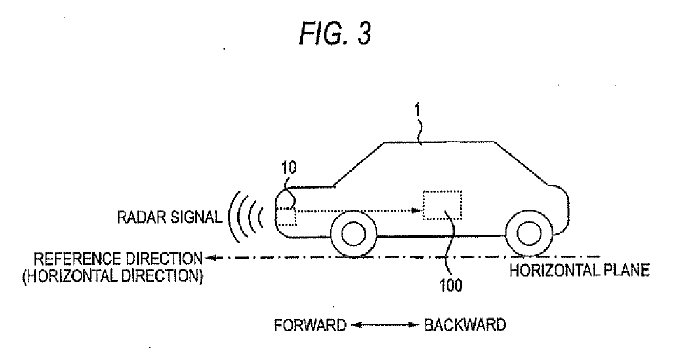

FIG. 3 is a schematic view illustrating a radar device according to a first embodiment of the present invention in a state where the radar device is installed on a vehicle. FIG. 3 shows an attachment position of the radar device 10 to the vehicle 1 when the radar device 10 scans the front side of the vehicle 1. The radar device 10 is attached in a front bumper or a front grille of the vehicle 1. The radar device 10 transmits a radar signal to the space in front of the vehicle 1 through the front grille or a decorative panel on the front surface of the front bumper and receives a reflected signal from the target. The radar device 10 detects the target located in the front space of the vehicle 1 by processing the transmitted and received signals.

The targets to be detected are mainly located on the same horizontal plane as the vehicle 1, such as other vehicles, pedestrians, or objects placed on the road. Accordingly, in order to detect those targets with high precision, it is preferable to direct the beam axis toward the reference direction in which the reception gain of the reflected signal from the target becomes largest. For this reason, when installing the radar device 10 on the vehicle 1 or at the time of subsequent vehicle checking, maintenance, the beam axis adjustment is performed so that the beam axis directs toward the reference direction. Here, the reference direction is a horizontal direction. Alternatively, the reference direction may be arbitrarily set by simulation or experiment. For example, the reference direction may be set to be low by about 0.5° from the horizontal direction.

The radar device 10 outputs the information on the detected target to a vehicle control device 100 of the vehicle 1. The vehicle control device 100 performs behavior control of the vehicle 1 on the basis of the target information detected by the radar device 10. For example, the vehicle control device 100 performs a travel control for following a preceding vehicle, a collision avoiding control for avoiding collision with an opposite vehicle, a pedestrian, and an object placed at the road, or the collision response control.

The radar device 10 may be attached to various positions of the vehicle 1 other than the example shown in FIG. 3. For example, when scanning the front side of the vehicle 1, the radar device 10 is attached in a fog lamp unit provided in a front side portion of the vehicle 1 and scans the space in front of the vehicle 1 to detect a target. When scanning the rear or the rear side, the radar device 10 is attached on the front surface or the side surface edge in a rear bumper of the vehicle 1, a tail lamp unit provided in a rear side portion, or the like and scans a space in the rear or the rear side of the vehicle 1 to detect a target. In any case, the beam axis adjustment is performed so that the beam axis directs toward the reference direction.

The radar device 10 in the embodiment has the housing 11 and the planar antenna 14, which is housed in the housing 11 and is tiltably provided with respect to the housing 11. The housing 11 is fixed to the vehicle 1 by fixtures 13. The tilt angle of the planar antenna 14 with respect to the gravity direction (the antenna angle of the planar antenna 14) can be changed by moving the planar antenna 14 relative to the housing 11 in a state where the housing 11 is attached to the vehicle 1, and the beam axis adjustment is performed so that the beam axis directs toward the reference direction.

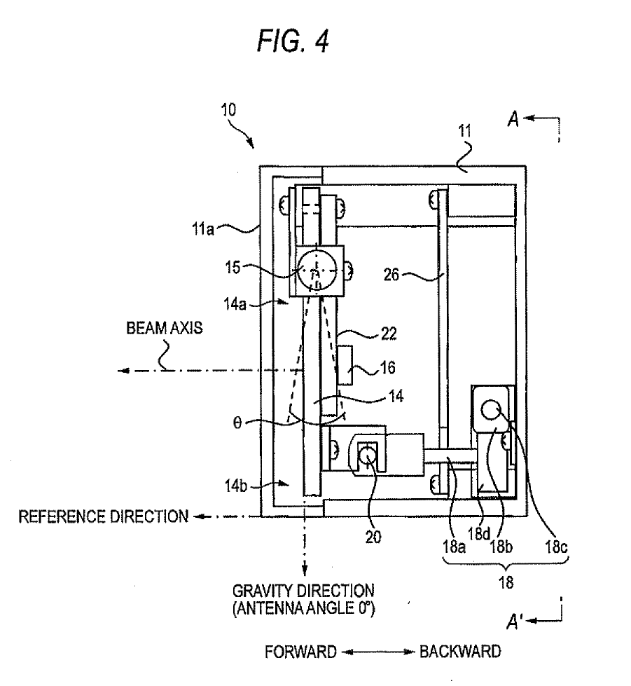

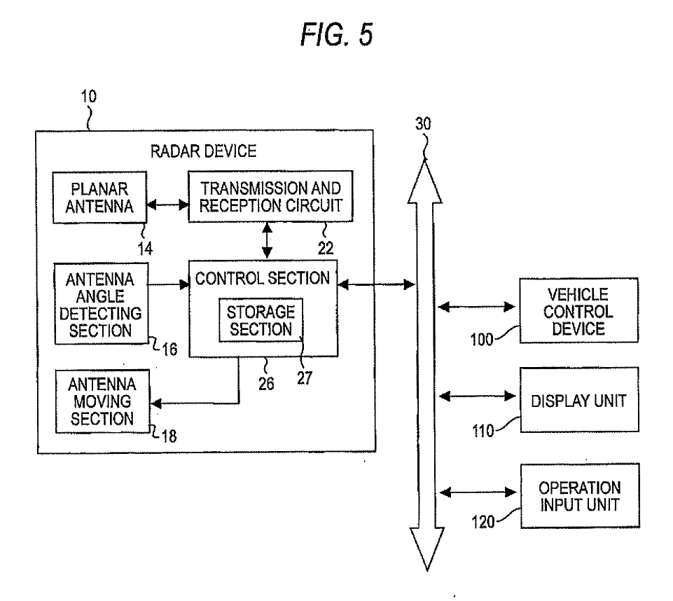

FIG. 4 is a cross-sectional view illustrating an internal structure of the radar device 10. FIG. 5 is a block diagram illustrating a configuration of the radar device 10. The configuration of the radar device 10 will be described in detail with reference to FIGS. 4 and 5.

As described above, the radar device 10 has the planar antenna 14 and various electronic circuits which are housed in the rectangular housing 11. A radome 11a is provided in a front portion of the housing 11.

An array or a patch is provided on the front surface of the planar antenna 14, and one end 14a of the planar antenna 14 is attached to the housing 11 through a tilting shaft 15 and the other end 14b is rotatably engaged with a sliding shaft 18a with a pin 20 in a state where the front surface is directed toward the front. The planar antenna 14 transmits a radar signal forward through the radome 11a. In this case, a beam axis is formed in a perpendicular direction (or approximately perpendicular direction) of the planar antenna 14.

The antenna moving section 18 has a sliding shaft 18a whose front end is engaged with the end 14b of the planar antenna 14 with the pin 20 and which is slidable back and forth, a motor 18b comprised of a DC motor or the like, and a deceleration mechanism 18d which decelerates a rotational motion of a shaft 18c of the motor 18b at the predetermined rate in order to convert the rotational motion into a sliding motion of the sliding shaft 18a. As an example, the deceleration mechanism 18d has a worm gear attached to the shaft 18c and a worm wheel to which the torque of the worm gear is transferred to slide the sliding shaft 18a. However, the deceleration mechanism 18d is not limited to such a structure as long as the deceleration mechanism 18d can convert the torque of the shaft 18c of the motor 18b into the sliding motion of the sliding shaft 18a.

The antenna moving section 18 slides the sliding shaft 18a forward/backward by performing positive rotation/negative rotation of the motor 18c. If the sliding shaft 18a slides forward/backward, the end 14b of the planar antenna 14 moves forward/backward. As a result, since the end 14b of the planar antenna 14 moves forward/backward around the tilting shaft 15, the antenna angle is adjusted.

An antenna angle detecting section 16 and a transmission and reception circuit 22 are provided on the back surface of the planar antenna 14. The antenna angle detecting section 16 is comprised of a tilt sensor such as an acceleration sensor, and detects the antenna angle of the planar antenna 14. FIG. 4 shows a state where the antenna angle is 0° with respect to the gravity direction. The transmission and reception circuit 22 is comprised of an oscillator which generates a radar signal (an electromagnetic wave) with a millimeter wavelength, as a main component, and supplies the radar signal to the planar antenna 14 and generates a beat signal by processing a reception signal of the planar antenna 14.

A control section 26 is provided behind the planar antenna 14 in the housing 11. The control section 26 is comprised of a motor driver and a microcomputer which includes a CPU (Central Processing Unit), a ROM (Read Only Memory; for example, a rewritable nonvolatile storage medium), and a RAM (Random Access Memory). The control section 26 controls operations of other sections by making the CPU execute a control program stored in the ROM using the RAM as a working area. Moreover, the ROM corresponds to a storage section 27 and stores various kinds of information required for control operation of the control section 26, which will be described in detail later.

The control section 26 controls an operation of the transmission and reception circuit 22 and detects the target on the basis of a beat signal generated by the transmission and reception circuit 22.

The control section 26 controls the driving of the motor 18b in the antenna moving section 18. In this case, the control section 26 acquires the antenna angle from a signal indicating the antenna angle, which is input from the antenna angle detecting section 16, and calculates the driving amount corresponding to a planned tilt angle and transmits it to the antenna moving section 18.

The control section 26 is connected to an in-vehicle network 30 of the vehicle 1. Through the in-vehicle network 30, the control section 26 can communicate with the vehicle control device 100, a display unit 110, and an operation input unit 120 which are installed on the vehicle 1.

The display unit 110 displays a message showing the warning transmitted from the control section 26 of the radar device 10, which will be described later. For example, the display unit 110 is comprised of a display device provided on an instrument panel of the vehicle 1 or an external information processing apparatus (for example, a personal computer) connected to the in-vehicle network 30.

The operation input unit 120 inputs a control signal which instructs the beam axis adjustment to the control section 26 of the radar device 10. For example, the operation input unit 120 is comprised of an ignition key of the vehicle 1, an electronic apparatus (for example, an in-vehicle electronic apparatus with a navigation function and/or an audio function) connected to the in-vehicle network 30, or a personal computer or an operation terminal provided outside the vehicle 1.

In the radar device 10 configured as described above, the beam axis adjustment is performed by controlling the antenna moving section 18 to move the planar antenna 14 so as to set the antenna angle to a reference antenna angle while monitoring the antenna angle by the control section 26 when the radar device 10 is installed on the vehicle. In this case, the control section 26 detects the antenna angle and calculates the driving amount corresponding to a planned tilt angle and then drives the antenna moving section 18. Then, the control section 26 detects the antenna angle again when the driving corresponding to the calculated driving amount ends and the control section 26 drives the antenna moving section 18 again for error correction. Alternatively, the driving amount may be controlled while performing feedback of the antenna angle in a predetermined period.

Here, if the forward tilt angle of the planar antenna 14 with respect to the housing 11 reaches a predetermined value, the planar antenna 14 comes in contact with the inner wall of the radome 11a and the sliding shaft 18a becomes unable to slide. As a result, the movement of the planar antenna 14 may be obstructed. On the contrary, if the backward tilt angle of the planar antenna 14 with respect to the housing 11 reaches a predetermined value, an engaged portion between the planar antenna 14 and the sliding shaft 18a comes in contact with the deceleration mechanism 18d or a rear end of the sliding shaft 18a comes in contact with the inner wall of the housing 11 on the back side and the sliding shaft 18a becomes unable to slide. As a result, the movement of the planar antenna 14 may be obstructed. In both the cases, if the sliding of the sliding shaft 18a is obstructed and the abnormal engagement occurs in the deceleration mechanism 18d, the deceleration mechanism 18d is fixed so that the sliding shaft 18a cannot slide any more. As a result, the planar antenna 14 becomes unable to move.

Therefore, a tiltable range θ of the planar antenna 14 which does not lead to the above situations is set in advance, and the planar antenna 14 is moved within the range. However, if the tilt angle of the housing 11 in the back and forth direction when performing the beam axis adjustment reaches a predetermined value, there is a possibility that the planar antenna 14 will be tilted exceeding the tillable range θ when the control section 26 control the antenna moving section 18 to move the planar antenna 14 while monitoring the antenna angle. Particularly when the tilt angle of the housing 11 significantly changes by vibration from the road surface during traveling or contact or collision with other vehicles, obstacles, after the first-time beam axis adjustment, the probability that the movement of the planar antenna 14 will exceed the tiltable range θ in the beam axis readjustment increases.

Therefore, the radar device 10 in the present embodiment stores a history of the tilt angle of the planar antenna 14 whenever performing the beam axis adjustment, and checks whether or not the movement can be performed within the tiltable range θ of the planar antenna 14 with respect to the housing 11 on the basis of the history when performing a new beam axis adjustment. Then, the planar antenna 14 is moved to adjust the antenna angle when it is checked that the movement can be performed within the tiltable range θ and the planar antenna 14 is not tilted if it is not checked that the movement cannot be performed within the tiltable range θ. In this way, even if the tilt angle of the housing 11 is significantly changed before the beam axis readjustment, it is possible to prevent the planar antenna 14 from moving by an angle exceeding the tiltable range θ. As a result, it is possible to avoid the situation where the abnormal engagement occurs in the deceleration mechanism 18d and the planar antenna 14 become unable to move.

If a sufficiently large space can be ensured in the housing 11, the situation where the planar antenna 14 cannot move can be avoided to some extent. However, according to the present embodiment, since it is not necessary to enlarge the housing 11, the radar device can be reduced in size.

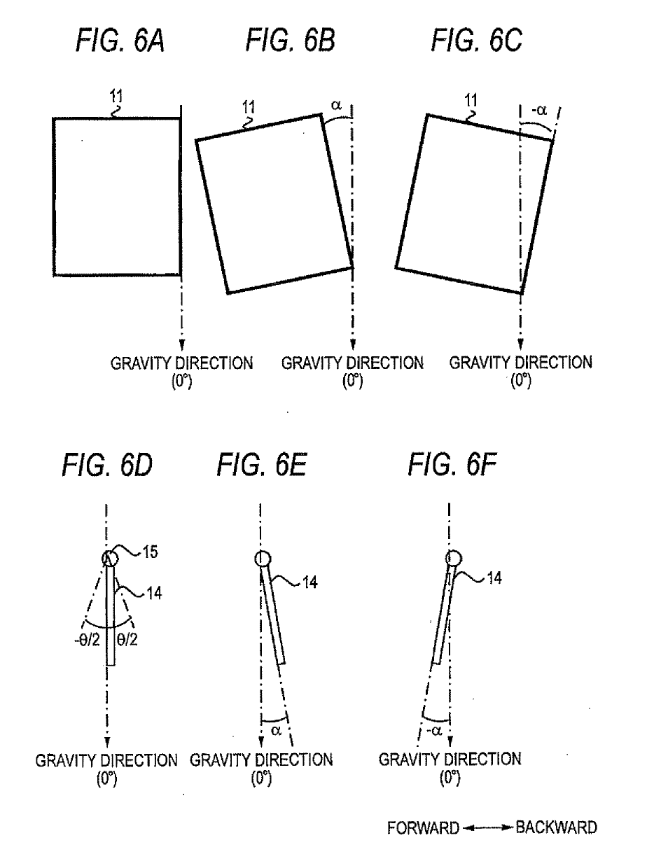

Here, an operation of the radar device 10 according to the first embodiment will be described with reference to FIGS. 6A to 10 in each case of the initial setting, the first-time beam axis adjustment, and the beam axis readjustment.

Hereinbelow, for the sake of convenience, the tilt angle to the front side is expressed as a positive value and the tilt angle to the rear side is expressed as a negative value. In order to make the following explanation easily understood, the tilt angle of the housing 11 with respect to the gravity direction, the antenna angle (the tilt angle of the planar antenna 14 with respect to the gravity direction), a tillable range of the planar antenna 14, and an angle by which the planar antenna 14 moves are shown in FIGS. 6A to 6F.

Assuming that the tilt angle of the housing 11 is 0° when the direction of the housing 11 matches the gravity direction (FIG. 6A), the tilt angle of the housing 11 is α° (>0°) when the housing 11 is inclined forward (FIG. 6B), and −α° when the housing 11 is inclined backward (FIG. 6C). Assuming that the antenna angle of the planar antenna 14 is 0° when the direction of the planar antenna 14 matches the gravity direction (FIG. 6D), the antenna angle of the planar antenna 14 is α° (>0) when the planar antenna 14 is inclined forward (FIG. 6E), and −α° when the planar antenna 14 is inclined backward (FIG. 6F). Moreover, as shown in FIG. 6D, the tiltable range 0 of the planar antenna 14 (>0) is set in the back and forth direction with the gravity direction from the tilting shaft 15 as a reference in a state where the housing 11 is placed on the horizontal plane. That is, the tillable range θ includes a rear angle range of (θ/2)° with respect to the front side and a front angle range of (−θ/2)° with respect to the rear side. The tiltable range θ may be set as an arbitrary value according to design.

In the beam axis adjustment, the planar antenna 14 is moved by an angle to adjust the antenna angle (the tilt angle of the planar antenna 14 with respect to the gravity direction) to the reference antenna angle (i.e. 0°). The angle by which the planar antenna 14 is moved in the beam axis adjustment is 0° when the antenna angle detected by antenna angle detecting section 16 is 0° (FIG. 6D), the angle is α° (that is, α° forward) when the detected antenna angle is α° (FIG. 6E), and the angle is −α° (that is, α° backward) when the detected antenna angle is −α° (FIG. 6F).

Hereinafter, for convenience of explanation, angles in the front direction expressed as positive values are exemplified as the tilt angle of the housing 11, the antenna angle and the angle by which the planar antenna 14 is moved in the beam axis adjustment. However, the following explanation is applied by setting the angle in the back direction as a negative value.

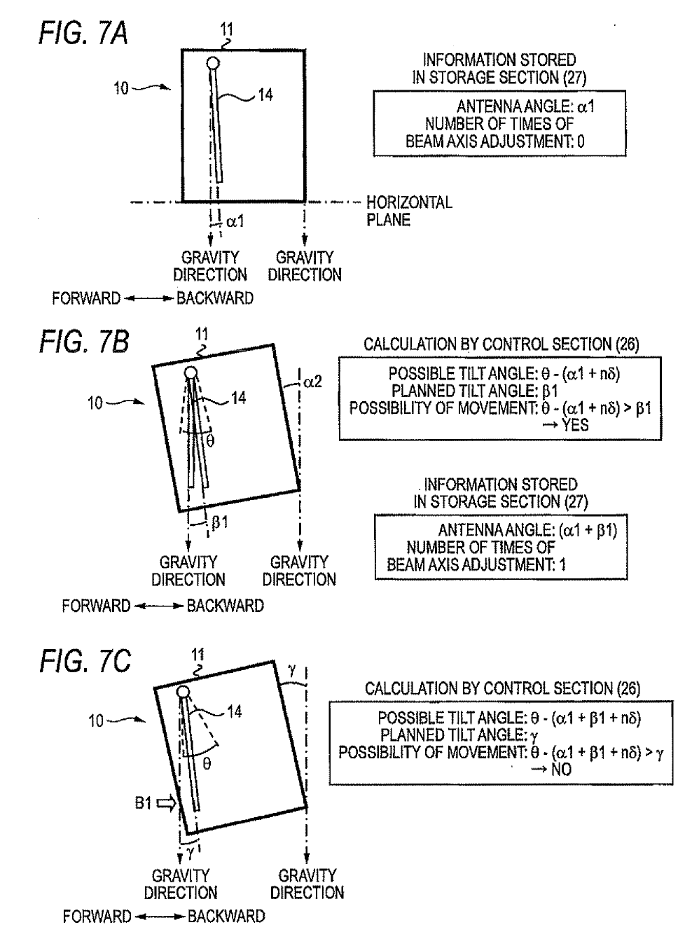

FIGS. 7A to 7C are schematic views each illustrating the radar device 10 for explaining the beam axis adjustment. FIG. 7A shows a state of the radar device 10 when the initial setting is performed. FIG. 7B shows a state of the radar device 10 when the radar device 10 is installed on the vehicle 1 and the first-time beam axis adjustment is performed. FIG. 7C shows a state of the radar device 10 when the beam axis readjustment is performed. FIGS. 7A to 7C also show content of operation processing of the control section 26 and information stored in the storage section 27 in each case of the initial setting, the first-time beam axis adjustment, and the beam axis readjustment.

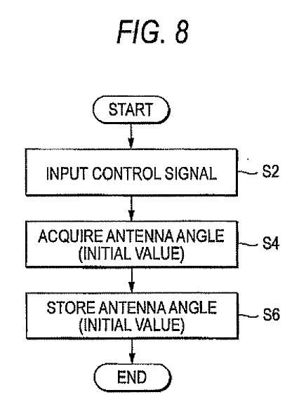

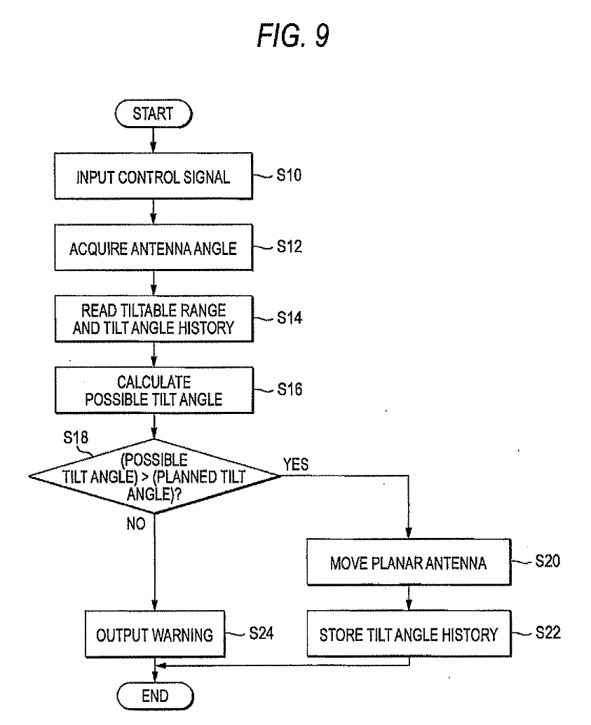

FIG. 8 is a flow chart illustrating the operation procedures of the radar device 10 in the state shown in FIG. 7A. FIG. 9 is a flow chart illustrating the operation procedures of the radar device 10 in the states shown in FIGS. 7B and 7C.

First, the initial setting of the radar device 10 will be described with reference to FIGS. 7A and 8. This operation is executed, for example, in a test process before shipping of the radar device 10.

As shown in FIG. 7A, the housing II is placed on the horizontal plane. In this state, the tilt angle of the housing 11 with respect to the gravity direction is 0°. On the other hand, the initial value of the antenna angle is α1°. This is due to the manufacture error of each radar device 10. The initial value α1° of the antenna angle is equal to 0° if it is as designed.

In this state, a control signal which instructs the initial setting is input from the operation input unit 120 to the control section 26 (S2). In response to the control signal, the control section 26 acquires the initial value α1° of the antenna angle detected by the antenna angle detecting section 16 (S4) and stores the initial value α1° of the antenna angle in the storage section 27 (S6). The storage section 27 also stores the number of times of the beam axis adjustment. Here, the number of times of beam axis adjustment is still 0 which is an initial value. In this manner, the initial setting operation is performed.

Next, the first-time beam axis adjustment of the radar device 10 will be described with reference to FIGS. 7B and 9. This first-time beam axis adjustment is performed, for example, in a test process after installing various electric components in a vehicle assembly process, in a state where the vehicle 1 is placed on the horizontal plane.

In FIG. 7B, the housing 11 is installed in the vehicle 1. In this state, the tilt angle of the housing 11 with respect to the gravity direction is α2°. This is due to an error during the installation work. The antenna angle is β1° (here, β1° corresponds to the sum of the initial value α1° and the tilt angle α2° of the housing 11).

In this state, a control signal which instructs the first-time beam axis adjustment is input from the operation input unit 120 to the control section 26 (S10). In response to the control signal, the control section 26 acquires the antenna angle β1° detected by the antenna angle detecting section 16 (S12). Here, a planned tilt angle by which the planar antenna 14 is to be moved is β1°.

Then, the control section 26 reads the tillable range θ of the planar antenna 14 and the history of the tilt angle of the planar antenna 14 from the storage section 27 (S14). Here, the antenna angle of α1° stored last time and the number of times of the beam axis adjustment of 0 are read as the history of the tilt angle.

Next, the control section 26 checks whether or not the antenna angle exceeds the tiltable range θ if the planar antenna 14 is moved by the planned tilt angle of β1°. In other words, the control section 26 determines whether the sum of the history of the tilt angle of the planar antenna 14 and the planned tilt angle β1° is within the tiltable range θ of the planar antenna 14 or beyond the tiltable range θ of the planar antenna 14. As a specific operation, a possible tilt angle is calculated by subtracting the history of the tilt angle from the tiltable range θ (S16). In consideration of the stopping accuracy of the planar antenna 14 by the antenna moving section 18, (α+nδ)° is derived as the history of the tilt angle of the planar antenna 14. Here, n is the number of times of the past beam axis adjustment, δ is an error caused by overrunning of the planar antenna 14. Accordingly, [θ−(α+nδ)]° is derived as the possible tilt angle.

The control section 26 then checks whether or not the planned tilt angle β1° exceeds the possible tilt angle. That is, it is checked whether or not θ−(α1+nδ)>β1 is satisfied (S18). As shown in FIG. 7B, even if the planar antenna 14 is moved by the planned tilt angle β1°, the planar antenna 14 is in the tiltable range θ, and thus the determination result in the procedure S18 is YES. In this way, it is determined that the sum of the history (α1+nδ) and the planned tilt angle β1° is within the tiltable range θ. Accordingly, the control section 26 controls the antenna moving section 18 to move the planar antenna 14 by the angle β1° to adjust the antenna angle to the reference antenna angle (S20) in order to direct the beam axis toward the reference direction. The control section 26 then stores the history of the tilt angle of the planar antenna 14 (S22). That is, the control section 26 stores the value of (α1β1)° in the storage section 27 and increments the number of times of the beam axis adjustment by 1. In this manner, the first-time beam axis adjustment is executed.

Next, the beam axis readjustment of the radar device 10 will be described with reference to FIGS. 7C and 9. This beam axis readjustment is performed, for example, in the checking and repair process for the vehicle 1 after the first-time beam axis adjustment, in a state where the vehicle 1 is placed on the horizontal plane.

In FIG. 7C, the tilt angle of the housing 11 with respect to the gravity direction is changed into γ° (>α2°). This is due to the vibration from the road surface during traveling or contact or collision with other vehicles and the like. When the tilt angle of the housing 11 is γ°, the antenna angle is also γ°, since the first-time beam axis adjustment has been performed when installing the radar device 10 in the vehicle 1.

In this state, a control signal which instructs the beam axis readjustment is input to the control section 26 (S10). In response to the control signal, the control section 26 acquires the antenna angle γ° detected by the antenna angle detecting section 16 (S12). Here, a planned tilt angle by which the planar antenna 14 is to be moved is γ°.

Then, the control section 26 reads the tiltable range θ of the planar antenna 14 and the history of tilt angle of the planar antenna 14 is read from the storage section 27 (S14). Here, the value of (α1+β1)° and the number of times of beam axis adjustment (i.e. 1) are read as the history of the tilt angle.

Next, the control section 26 calculates the possible tilt angle (S16) and checks whether or not the planned tilt angle γ° exceeds the possible tilt angle (S18). That is, it is checked whether or not θ−(α1+β1+nδ)>γ is satisfied. In this way, it is determined whether the sum of the history (α1+β1+nδ) and the planned angle γ° is within the tiltable range θ or beyond the tiltable range θ.

If the determination result in the procedure S18 is YES, the control section 26 controls the antenna moving section to move the planar antenna 14 by the angle γ° to adjust the antenna angle to the reference antenna angle (S20) and stores, the value of (α1+β1+γ)° in the storage section 27 and increment the number of times of the beam axis adjustment by 1 (S22). In this manner, the beam axis readjustment is executed. In addition, even when the beam axis readjustment is executed again and again, the same procedures as above are executed if the planar antenna 14 can be moved within the tiltable range θ. In each case, the history of the tilt angle of the planar antenna 14 is updated and stored in the storage section 27.

In FIG. 7C, however, the antenna angle exceeds the tiltable range θ if the planar antenna 14 is moved by the planned tilt angle of γ°. In other words, it is determined that the sum of the history of tilt angle (α1+β1+nδ) and the planned tilt angle γ° is beyond the tiltable range θ. Accordingly, in this case, the determination result in the procedure S18 is NO. Accordingly, the control section 26 ends the processing of the beam axis readjustment and the antenna moving section does not move the planar antenna 14 by the planned tilt angle γ°. In this way, it is possible to prevent a situation where the planar antenna 14 comes in contact with the inner wall of the housing 11 and cannot return to the original state. Preferably, before ending the processing, a warning message is output to the display unit 110 (S24). In this situation, it is likely that the tilt angle of the housing 11 is significantly changed because a fixture that attaches the housing 11 to the vehicle 1 may have a problem or a vehicle body of the vehicle 1 may be deformed. Thus, by displaying the warning massage on the display unit 110, it is possible to encourage the driver or the worker to perform the adjustment of the fixture of the housing 11 or the maintenance of the vehicle body.

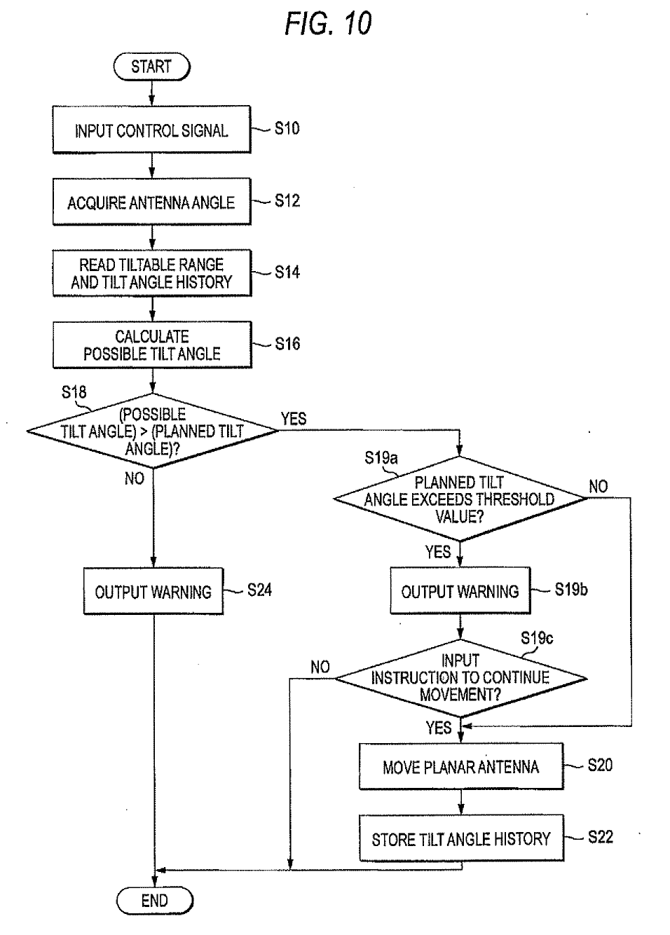

FIG. 10 is a flow chart illustrating the operation procedures of the beam axis readjustment in a preferable embodiment. In FIG. 10, procedures 19a, 19b, and 19c are added between the procedures S18 and 520 in the flow chart shown in FIG. 9. Even if it is determined that the planned tilt angle is smaller than the possible tilt angle (YES in S18), when the planned tilt angle exceeds a predetermined threshold value (YES in S19a), the control section 26 outputs a warning message (S19b). With this configuration, the defect of the vehicle body of the vehicle 1 can be detected early, it is possible to encourage the driver or the worker to perform the maintenance of the vehicle 1. In this case, however, if an instruction to continue the movement of the planar antenna 14 is input (YES in S19c), the beam axis adjustment is executed (S20). Since the beam axis adjustment can be executed as described above, the beam axis adjustment can be completed while warning of the possibility of a problem in the vehicle body. As a result, user convenience can be improved.

In addition, the threshold value may change with the number of times of the beam axis adjustment. That is, the threshold value may be set to a relatively large value when installing the radar device 10 in the vehicle 1, so that the tilt angle of the housing 11 occurring by manual operation can be covered. Moreover, the threshold value may also be set to a smaller value than the original value at the time of the beam axis readjustment, so that it can be checked whether or not the planned tilt angle is in the fine adjustment range in the beam axis readjustment and it is possible to quickly detect that a problem has occurred in the fixture of the housing 11 or the vehicle body if the planned tilt angle is not in the fine adjustment range.

The antenna angle detecting section may be realized by providing a sensor which detects the tilt angle of the housing 11 with respect to the gravity direction instead of providing the antenna angle detecting section 16 which detects the tilt angle of the planar antenna 14 with respect to the gravity direction (the antenna angle). In this instance, the control section 26 can calculate the antenna angle on the basis of the history of tilt angle of the planar antenna 14 and the tilt angle of the housing 11 detected by the sensor.

The detection procedure of the antenna angle in this case will be described with reference to FIGS. 7A to 7C. In FIG. 7A, since the housing 11 is placed on the horizontal plane, the tilt angle of the housing 11 is 0°. Accordingly, the designed initial value α1° (preferably, 0°) is detected as the antenna angle. In FIG. 7B, since the tilt angle of the housing 11 is α2°, (α2+α1)° is detected as the antenna angle. In FIG. 7C, since the tilt angle of the housing 11 is γ°, (γ−β1)° is detected as the antenna angle. Also in this modification, it is possible to avoid the situation where the antenna angle cannot be adjusted at the time of the beam axis adjustment.

In the above explanation, the planar antenna 14 is tiltably provided with respect to the housing 11 through the tilting shaft 15. The attachment structure of planar antenna 14 to the housing 11 is not limited thereto. For example, one end of the planar antenna 14, which is to be attached to the housing 11 may be bent such that the planar antenna 14 can be tiltably provided with respect to the housing 11 without using the tilting shaft.

Moreover, in the above explanation, the case is shown in which the tilt angle of the housing 11 continuously changes in the forward direction and accordingly, the planar antenna 14 is moved forward. However, the above explanation may also be applied to the case in which the tilt angle of the housing 11 continuously changes backward and accordingly, the planar antenna 14 is moved backward. Moreover, for example, even in the case where the housing 11 is inclined forward and is then inclined backward or in the opposite case, the possible tilt angle can be calculated by subtracting the sum of the history of tilt angle stored in the storage section 27 from the tiltable range as described above.

As described above, according to the first embodiment, it is possible to avoid the situation where the planar antenna cannot be moved at the time of the beam axis adjustment. As a result, it is possible to improve the working efficiency at the time of the beam axis adjustment and to improve the user convenience without enlarging the housing of the radar device.

### Second Embodiment

### 1. System Configuration

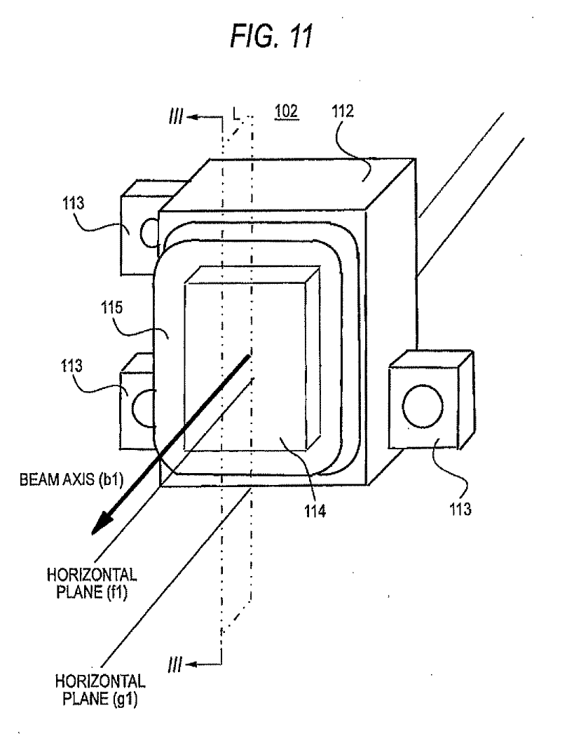

FIG. 11 is a perspective view illustrating a radar device 102 which performs an antenna adjustment. The radar device 102 has a housing 112 and an antenna 114 provided in the housing 112. The housing 112 is fixed to a vehicle body by a fixing bolt 113. Moreover, in the second embodiment, it is assumed that the beam axis direction of the antenna 114 is parallel to the horizontal plane f1 when the antenna surface of the antenna 114 is perpendicular to the horizontal plane g1 in a state where the radar device 102 is located in parallel with the horizontal plane g1. In addition, the following explanation will be given assuming the case, in which the beam axis direction is parallel to the horizontal plane f1 in such a state where the radar device 102 is located in parallel with the horizontal plane g1, as the target angle of the antenna 114 at which a reflected wave from an object can have a reflection intensity equal to or larger than a fixed value.

The antenna 114 is comprised of a planar antenna, such as a patch antenna or an array antenna with antenna elements arrayed on the front surface. The antenna 114 forms a beam axis direction in the perpendicular direction (parallel to the horizontal plane) of the antenna 114 through a radome 115 so that a transmission wave is transmitted and a reflected wave from an object is received. In addition, the antenna 114 may adjust the antenna angle so that the reflected wave on the object of the transmission wave is received with predetermined reflection intensity. Details of the adjustment of the antenna angle will be described later.

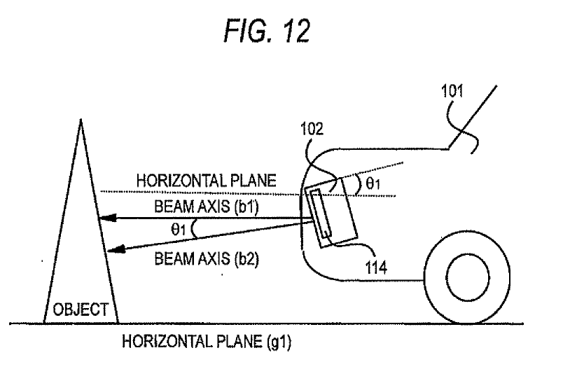

FIG. 12 is a schematic view illustrating the radar device 102 installed on the vehicle 101. In the second embodiment, the radar device 102 is installed on the vehicle 101 in a state of being inclined by an angle of θ1 from the horizontal plane g1 due to the skill of a worker or the installation space of the radar device 102 which changes with the type of the vehicle 101 in which the radar device 102 is installed. Therefore, the antenna angle also corresponds to a beam axis b2 which is a beam axis direction with a tilt angle of the antenna inclined by θ1 from a beam axis b1 that is a beam axis direction parallel to the horizontal plane.

As a result of the tilt angle of the antenna, the angle of the antenna 114 does not become a beam axis direction in which the reflection intensity equal to or larger than a fixed value can be obtained for the object. In addition, the reflection intensity equal to or larger than the fixed value referred to herein means a reflection intensity with which the distance, the relative velocity, and the angle of an object existing in the detection range of the radar device 102 can be detected.

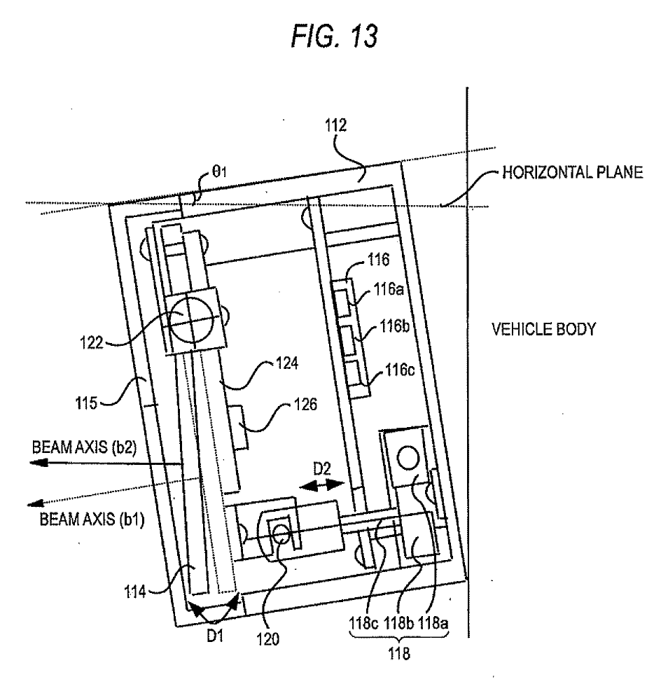

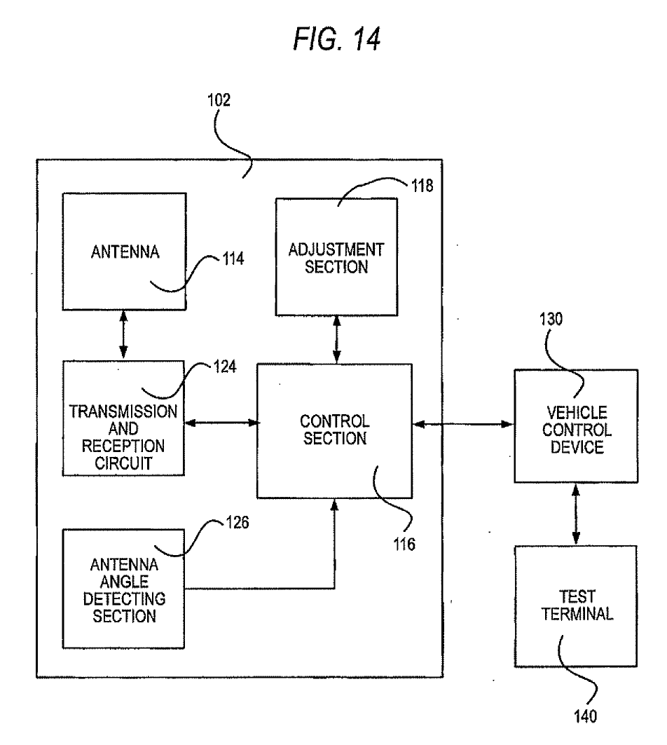

Next, the configuration in which the angle of the antenna 114 is adjusted from the antenna angle before adjustment to the target angle will be described. FIG. 13 is a cross-sectional view illustrating an internal structure of the radar device 102 taken along a line III-III shown in FIG. 11. FIG. 14 is a block diagram illustrating a configuration of the radar device 102.

One end of the antenna 114 is connected to the housing 112 through a tilting shaft 122 so as to be able to tilt, and the other end of the antenna 114 is connected to a sliding shaft 118c through a pin 120 so as to be rotatable. An adjustment section 118 which changes the angle of an antenna is configured to include a motor 118a, a deceleration mechanism 118b which decelerates the rotating speed of the motor 118a at the predetermined rate and converts the rotational motion into reciprocating driving of the sliding shaft 118c, and the sliding shaft 118c.

When the adjustment section 118 drives the sliding shaft 118c to reciprocate as shown by arrow D2, the end of the antenna 114 tilts around the tilting shaft 122 as shown by arrow D1 according to the reciprocation of the sliding shaft 118c. As a result, the antenna angle changes such that the angle adjustment is performed.

An antenna angle detecting section 126 which detects the angle of the antenna 114 is provided on the back surface of the antenna 114. Examples of the antenna angle detecting section 126 include a tilt sensor and a yaw rate sensor. In addition, a transmission and reception circuit 124, which generates a transmission signal of a transmission wave output from the antenna 114 and supplies the transmission signal to the antenna element and which processes the received signal from the antenna element, is provided on the back surface of the antenna 114.

In addition, a control section 116 that controls the radar device 102 and that includes a motor driver and a microcomputer, which includes a CPU (Central Processing Unit) 116a that performs object detection processing, a ROM (Read Only Memory) 116b that stores data required for the CPU 116a to perform the object detection processing, and a RAM (Random Access Memory) 116c that temporarily stores the data when performing the object detection processing, is provided in the housing 112. The control section 116 instructs the adjustment section 118 to drive the motor and determines the amount of driving.

The amount of driving is determined on the basis of the angle difference between the target angle and the antenna angle before adjustment after the CPU 116a reads the target angle of the antenna 114 stored beforehand in the ROM 116b and detects the antenna angle before adjustment input from the antenna angle detecting section 126.

The control section 116 controls the operation of the transmission and reception circuit 124 in the object detection processing and detects the information, such as the position, the relative velocity, and the angle of the object, on the basis of the transmission and reception signals of the antenna 114 processed by the transmission and reception circuit 124. Then, the control section 116 transmits the detected object information to a vehicle control device 130 which is electrically connected with the control section 116.

Moreover, in the angle adjustment of an antenna, the control section 116 detects the antenna angle before adjustment using the antenna angle detecting section 126 and reads the target angle from the memory 116b in the control section 116. In addition, from the information of the antenna angle before adjustment and the target angle, the control section 116 calculates the antenna estimation angle for every time which is a criterion for determining whether or not planned adjustment from the antenna angle before adjustment to the target angle is performed. In addition, the control section 116 detects an error between the antenna estimation angle, which is an adjustment estimation value, and an antenna angle for every time while adjustment from the antenna angle before adjustment to the target angle is being performed.

Moreover, in the angle adjustment of the antenna 114, the control section 116 detects the antenna angle before adjustment using the antenna angle detecting section 126 and reads the target angle from the ROM 116b in the control section 116. In addition, from the information of the antenna angle before adjustment and the target angle, the control section 116 calculates an adjustment completion estimation time which is a criterion for determining whether or not the adjustment to the target angle is performed as planned. In addition, the control section 116 detects an error between the adjustment completion estimation time, which is an adjustment estimation value, and an adjustment completion time from the antenna angle before adjustment to the target angle.

Moreover, when the allowable error range set beforehand is exceeded in the antenna angle adjustment, the control section 16 notifies the user that an angle adjustment error has occurred by operating a warning device provided inside or outside the radar device 102 and also transmits to the adjustment section 118 a signal for stopping the angle adjustment of the antenna 114.

The vehicle control device 130 is electrically connected to the control section 116 and makes instructions to execute various kinds of vehicle control, such as a brake operation or an accelerator operation, for various vehicle apparatuses. The vehicle control device 130 is communicably connected with a test terminal 140, such as a personal computer.

The test terminal 140 transmits an instruction for starting antenna angle adjustment to the control section 116 of the radar device 102 through the vehicle control device 130 at the time of antenna angle adjustment or serves as a display device which displays a situation of the antenna angle adjustment for the user. In addition, the test terminal 140 may perform the error detection processing of the antenna angle or the like for every time while adjustment from the antenna angle before adjustment to the target angle is being performed or the processing of detecting the error between the adjustment completion estimation time, which is the adjustment estimation value, and the adjustment completion time from the antenna angle before adjustment to the target angle, which is performed when the control section 116 performs antenna angle adjustment.

### 2. Error Detection in Antenna Angle Adjustment

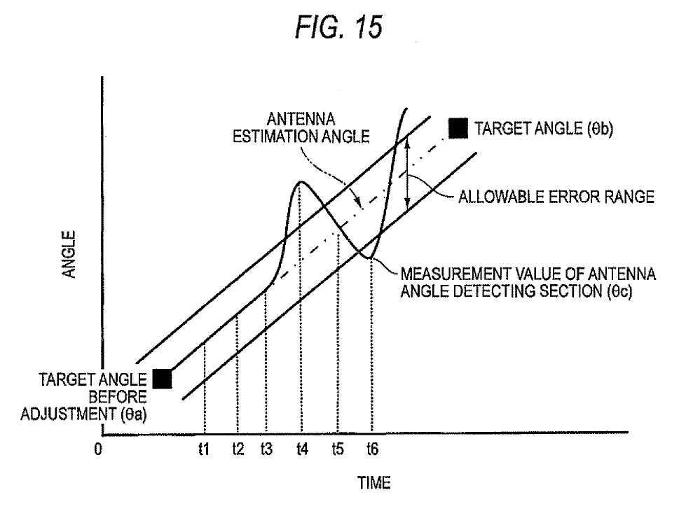

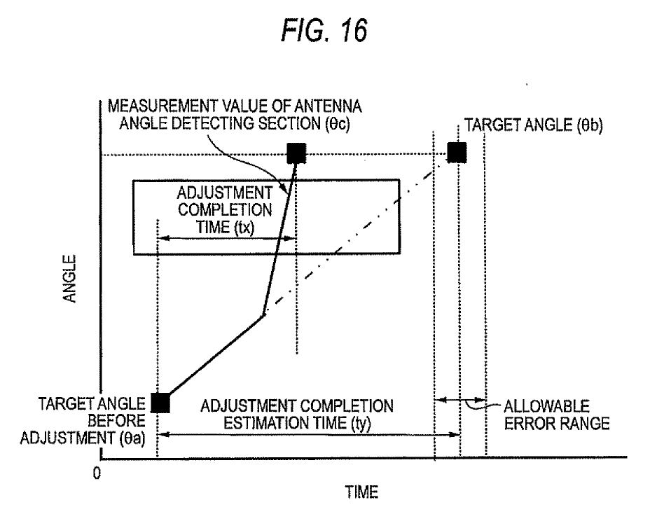

Next, specific processing of detecting an error in angle adjustment will be described. FIG. 15 is an explanatory diagram showing a state where an angle error occurs at the time of antenna angle adjustment. For example, FIG. 15 is a graph showing that an adjustment error has occurred in the antenna angle due to having opened and closed the door of the vehicle 101 by the worker at the time of angle adjustment of the antenna 114. FIG. 16 is an explanatory diagram showing a state where an adjustment time error occurs at the time of antenna angle adjustment. For example, FIG. 16 is a graph showing that an adjustment error occurs in the antenna angle due to contact with a vehicle, such as getting on and off the vehicle by a worker, at the time of angle adjustment of the antenna 114. In each of the graphs, the vertical axis indicates an angle and the horizontal axis indicates a time.

In the processing of performing angle adjustment of the antenna 114, an antenna angle θa before adjustment which is a current angle of the antenna 114 is detected by the antenna angle detecting section 126. Then, a target angle θb is read from the ROM 116b of the control section 116 and is set as an antenna estimation angle, which is an adjustment estimation value for every predetermined time that changes from the antenna angle θa before adjustment to the target angle θb, as shown in FIG. 15. The antenna estimation angle is a criterion for determining whether or not planned adjustment to the target angle is performed. Moreover, as shown in FIG. 15, an allowable error range, which is the range of an error that can be allowed from the antenna estimation angle, is set so that the angle adjustment of the antenna 114 is stopped or the user is notified by alarm when the allowable error range is exceeded.

In addition, the allowable error range which is the range of an error that can be allowed is also set for the adjustment completion estimation time of estimation time at which the adjustment from the antenna angle θa before adjustment to the target angle θb is completed, as shown in FIG. 16. In addition, the CPU 116a of the control section 116 calculates the adjustment completion estimation time on the basis of the information regarding the adjustment angle of the antenna and the adjustment speed of the antenna angle. The adjustment completion estimation time is also a criterion for determining whether or not planned adjustment to the target angle is performed so that the angle adjustment of the antenna 114 is stopped or the user is notified by alarm when the allowable error range is exceeded.

The following explanation will be given by setting the antenna estimation angle as the adjustment estimation value in FIG. 15 and the adjustment completion estimation time as the adjustment estimation value in FIG. 16. In FIG. 15, adjustment starts from the antenna angle θa before adjustment, and an error between the antenna estimation angle and an antenna angle θc of the measurement value that the antenna angle detecting section 126 detects every predetermined time (for example, every 10 msec) is calculated. Specifically, there is no error between the antenna angle θc and the antenna estimation angle from time t1 to t3 of the graph, and an error which exceeds the allowable error range is detected at time t4. Therefore, at the point of time when the error exceeding the allowable error range has occurred, the angle adjustment is stopped or an alarm indicating that an error has occurred in the adjustment to the target angle of the antenna 114 is generated. As a result, since a malfunction of the radar device 102 can be prevented in advance, safe vehicle control can be provided for the user who uses the vehicle 101. For example, in the case where antenna angle adjustment is performed at a vehicle factory, a dealer, or the like, it is possible to prevent erroneous angle adjustment occurring when vibration, which is caused by opening and closing of the vehicle door by a worker at the time of antenna angle adjustment after attaching a radar device to the vehicle, is given to the vehicle.

In addition, the adjustment work may not be stopped or an alarm may not be generated just because the allowable error range is exceeded by onetime detection, but antenna adjustment may be stopped or an alarm may be generated by determining that an error has occurred in adjustment to the target angle of the antenna 114 when the antenna angle detecting section 126 detects the antenna angle θc at a timing corresponding to each of the plurality of points of time t1 to t6 and an error between the angle transition estimation value and the angle detected at each point of time is equal to or larger than a predetermined value and the error is calculated a plural number of times. For example, since the number of detections, in which the error exceeds the allowable error range, among six detections from time t1 to t6 is calculated as a plural number of times of t4 and t6 in FIG. 15, an alarm is generated or the angle adjustment is stopped.

In FIG. 16, adjustment starts from the antenna angle θa before adjustment, and an adjustment completion estimation time ty until it becomes the target angle θb is calculated beforehand. Moreover, it is assumed that adjustment to the target angle θb has been completed if an adjustment completion time tx when the antenna angle θa before adjustment becomes the target angle θb is equal to the adjustment completion estimation time ty or is in the allowable error range.

Moreover, in the present embodiment, if the adjustment completion time tx is not equal to the adjustment completion estimation time ty and is not in the allowable error range, an alarm is generated or the adjustment work is stopped since an error has occurred in the adjustment to the target angle of the antenna 114. As a result, since a malfunction of the radar device 102 can be prevented in advance, safe vehicle control can be provided for the user who uses the vehicle 101. For example, in the case where antenna angle adjustment is performed at a vehicle factory, a dealer, or the like, it is possible to prevent erroneous angle adjustment occurring when vibration caused by contact with a vehicle, such as getting on and off the vehicle by a worker, at the time of antenna angle adjustment after attaching a radar device to the vehicle, is given to the vehicle.

### 3. Operation of First Antenna Angle Adjustment

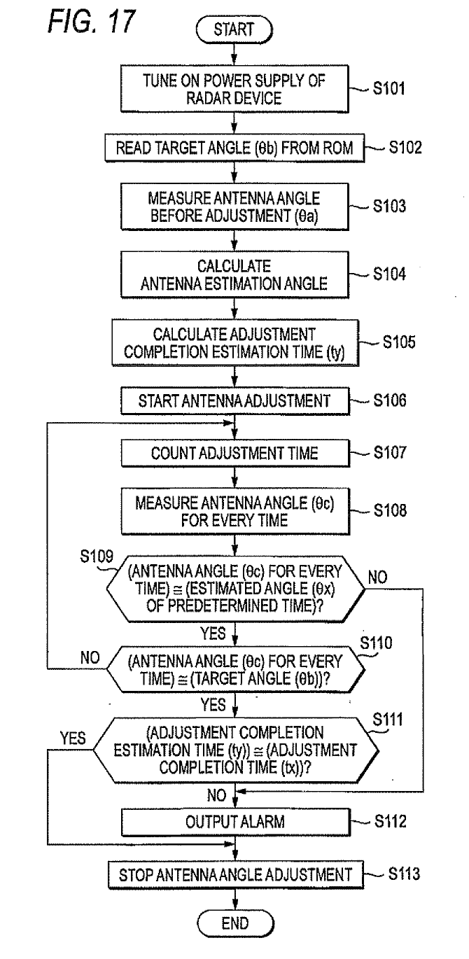

Next, an operation of error detection in the first antenna angle adjustment will be described with reference to the processing flow chart in FIG. 17. When performing error detection in antenna angle adjustment, the test terminal 140 is connected to the vehicle control device 130 and a power supply of the radar device 102 is turned on to start the adjustment operation (step S101).

As the information required to perform the adjustment, the target angle θb of the antenna 114 that makes a beam axis direction, in which the reflection intensity equal to or larger than a fixed value can be obtained from an object, is read from the ROM 116b (step S102).

Then, the antenna angle θa before adjustment is measured by the antenna angle detecting section 126 (step S103), and the antenna estimation angle which estimates a change from the antenna angle θa before adjustment to the target angle θb is calculated as an adjustment estimation value (step S104). In addition, an allowable error range of a predetermined angle range is set according to the calculation result of the antenna estimation angle.

Then, the adjustment completion estimation time ty, which is a time taken for the adjustment from the antenna angle θa before adjustment to the target angle θb, is calculated (step S105). Then, angle adjustment of the antenna 114 from the antenna angle θa before adjustment to the target angle θb is started (step S106). Then, counting of the adjustment time is started simultaneously with the start of the adjustment (step S107), and the angle θc of the antenna under adjustment at each time is measured to detect the measurement value according to the angle variation of the antenna (step S108).

The antenna angle θc at each time is compared with an estimated angle θx at each time. If the antenna angle θc is equal to the estimated angle θx or is in the allowable error range (Yes in step S109), it is determined whether or not the antenna angle θc at each time is equal to the target angle θb or is in the allowable error range (step S110).

In addition, after comparing the antenna angle θc at each time with the estimated angle θx at each time, if the antenna angle θc is not equal to the estimated angle θx and is not in the allowable error range (No in step S109), an alarm is output to the worker in a vehicle factory, a dealer, or the like (step S112) and then the antenna angle adjustment is stopped (step S113).

If the antenna angle θc at each time is not within the range of the target angle θb (No in step S110) in the processing of step S110, the counting of the adjustment time is continuously executed (step S107) and the processing of measuring the antenna angle θc at each time (step S108) is continued. In addition, if the antenna angle θc at each time is equal to the target angle θb or is in the error detection range (Yes in step S110), the adjustment of the antenna 114 is ended and it is determined whether or not the adjustment completion estimation time ty estimated beforehand is equal to the adjustment completion time tx or is in the allowable error range (step S111).

Then, if the adjustment completion estimation time ty is equal to the adjustment completion time tx or is in the allowable error range (Yes in step S111), the antenna angle adjustment is stopped (step S113). In addition, if the adjustment completion estimation time ty is not equal to the adjustment completion time tx and is not in the allowable error range (No in step S111), an alarm is output to the worker in the vehicle factory, the dealer, or the like (step 5112) and then the antenna angle adjustment is stopped (step S113).

Thus, by performing angle adjustment of an antenna while detecting the error between the adjustment estimation value of the antenna angle and the measurement value according to the angle variation of the antenna, it is possible to prevent erroneous angle adjustment caused by the factors occurring during the angle adjustment. As a result, accurate angle adjustment to the target angle can be performed. For example, in the case where antenna angle adjustment is performed in a vehicle factory, a dealer, or the like, it is possible to prevent erroneous angle adjustment occurring when vibration caused by contact with a vehicle, such as opening and closing of a vehicle door or getting on and off the vehicle by a worker, at the time of antenna angle adjustment after attaching a radar device to the vehicle, is given to the vehicle. In addition, since a malfunction of the radar device can be prevented in advance, safe vehicle control can be provided for the user who uses the vehicle 101.

In the first antenna angle adjustment processing described until now, processing of performing the error detection in any cases of the state, in which the angle error occurs at the time of antenna angle adjustment as shown in FIG. 15, and the state, in which the adjustment time error occurs at the time of antenna angle adjustment as shown in FIG. 16, has been described. Apart from this, it is possible to detect an error when an angle error occurs in the midst of antenna angle adjustment, or it is possible to detect an error when an adjustment time error occurs in the midst of antenna angle adjustment. These processing options will be described below as second antenna angle adjustment processing and third antenna angle adjustment processing.

### 4. Operation of Second Antenna Angle Adjustment

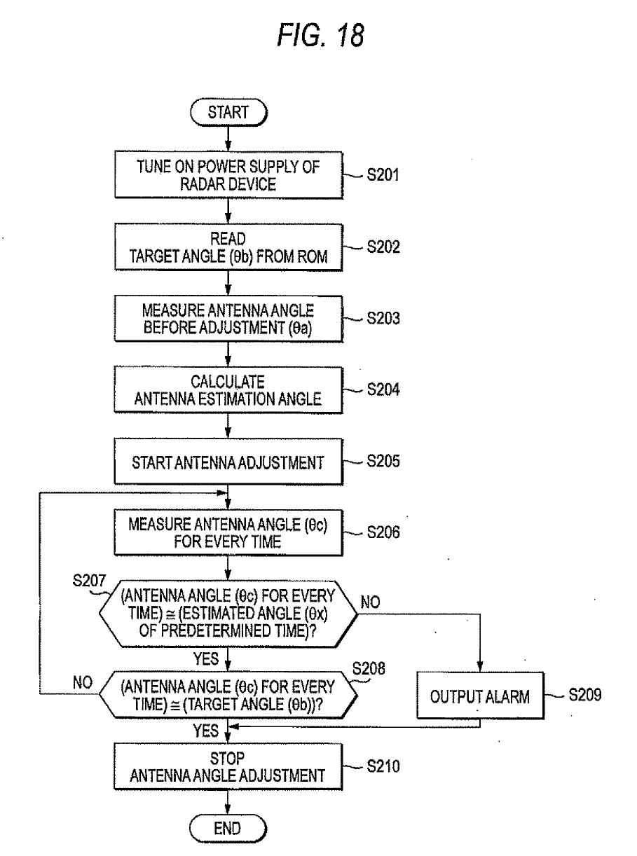

The second antenna angle adjustment shown in FIG. 18 is to detect an error when an angle error occurs at the time of antenna angle adjustment. When performing error detection in antenna angle adjustment, the test terminal 140 is connected to the vehicle control device 130 and a power supply of the radar device 102 is turned on to start the adjustment operation (step S201).

As the information required to perform the adjustment, the target angle θb of the antenna 114 that makes a beam axis direction, in which the reflection intensity equal to or larger than a fixed value can be obtained from an object, is read from the ROM 116b (step S202).

Then, the antenna angle θa before adjustment is measured by the antenna angle detecting section 126 (step S203), and the antenna estimation angle which estimates a change from the antenna angle θa before adjustment to the target angle θb is calculated as an adjustment estimation value (step S204). In addition, an allowable error range of a predetermined angle range is set according to the calculation result of the antenna estimation angle.

Then, angle adjustment of the antenna 114 from the antenna angle θa before adjustment to the target angle θb is started (step S205). Then, the angle θc of the antenna 114 under adjustment at each time is measured (step S206).

The antenna angle θc at each time is compared with the estimated angle θx at each time. If the antenna angle θc of the antenna under adjustment is equal to the estimated angle θx or is in the allowable error range (Yes in step S207), it is determined whether or not the antenna angle θc at each time is equal to the target angle θb or is in the allowable error range (step S208).

In addition, after comparing the antenna angle θc at each time with the estimated angle θx at each time, if the antenna angle θc is not equal to the estimated angle θx and is not in the allowable error range (No in step S207), an alarm is output to the worker in a vehicle factory, a dealer, or the like (step S209) and then the antenna angle adjustment is stopped (step S210).

If the antenna angle θc at each time is not within the range of the target angle θb (No in step S208) in processing of step S208, the processing of measuring the antenna angle θc at each time (step S206) is continued. In addition, if the antenna angle θc at each time is equal to the target angle θb or is in the allowable error range (Yes in step S208), the angle adjustment of the antenna 114 is stopped (step S210).

Thus, by performing angle adjustment of an antenna while detecting the error between the estimated angle of the antenna and the antenna angle, it is possible to finely check the antenna angle for every time during the angle adjustment. As a result, since it is possible to prevent erroneous angle adjustment caused by the factors occurring during the angle adjustment, accurate angle adjustment to the target angle can be performed. For example, in the case where antenna angle adjustment is performed at a vehicle factory, a dealer, or the like, it is possible to prevent erroneous angle adjustment occurring when vibration, which is caused by opening and closing of the vehicle door by a worker at the time of antenna angle adjustment after attaching a radar device to the vehicle, is given to the vehicle.

### 5. Operation of Third Antenna Angle Adjustment

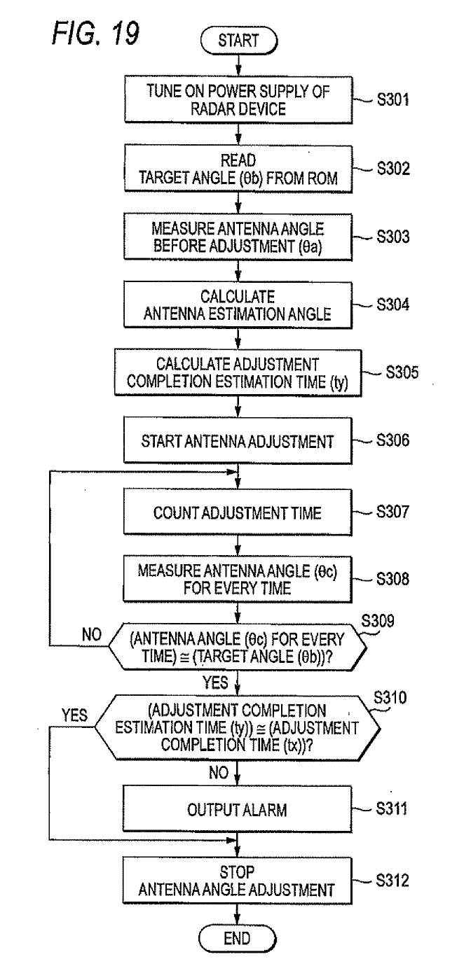

The third antenna angle adjustment shown in FIG. 19 is to detect an error when a time error occurs at the time of antenna angle adjustment. The test terminal 140 is connected to the vehicle control device 130 and a power supply of the radar device 102 is turned on to start the adjustment operation (step S301).

As the information required to perform the adjustment, the target angle θb of the antenna 114 that makes a beam axis direction, in which the reflection intensity equal to or larger than a fixed value can be obtained from an object, is read from the ROM 116b (step S302).

Then, the antenna angle θa before adjustment is measured by the antenna angle detecting section 126 (step S303), and the antenna estimation angle which estimates a change from the antenna angle θa before adjustment to the target angle θb is calculated as an adjustment estimation value (step S304). In addition, an allowable error range of a predetermined angle range is set according to the calculation result of the antenna estimation angle.

Then, the adjustment completion estimation time ty, which is a time taken for the adjustment from the antenna angle θa before adjustment to the target angle θb, is calculated (step S305). Then, angle adjustment of the antenna 114 from the antenna angle θa before adjustment to the target angle θb is started (step S306). Then, counting of the adjustment time is started simultaneously with the start of the adjustment (step S307), and the angle θc at each time is measured to detect the measurement value according to the angle variation of the antenna (step S308).

Then, it is determined whether or not the angle θc at each time is equal to the target angle θb or is in the allowable error range (step S309). If the antenna angle θc at each time is not within the range of the target angle θb (No in step S309) in the processing, the counting of the adjustment time is continuously executed (step S307) and the processing of measuring the antenna angle θc under adjustment (step S308) is continued. In addition, if the antenna angle θc at each time is equal to the target angle θb or is in the error detection range (Yes in step S309), the adjustment of the antenna 114 is ended and it is determined whether or not the adjustment completion estimation time ty estimated beforehand is equal to the adjustment completion time tx or is in the allowable error range (step S310).

If the adjustment completion estimation time ty is equal to the adjustment completion time tx or is in the allowable error range (Yes in step S310), the antenna angle adjustment is stopped (step S312). In addition, if the adjustment completion estimation time ty is not equal to the adjustment completion time tx and is not in the allowable error range (No in step S310), an alarm is output to the worker in the vehicle factory, the dealer, or the like (step S311) and then the antenna angle adjustment is stopped (step S312).

Thus, by detecting the error between the time from the start of antenna angle adjustment to the completion and the adjustment completion estimation time, it is possible to prevent erroneous angle adjustment caused by the adjustment time difference. As a result, accurate angle adjustment to the target angle can be performed. For example, in the case where antenna angle adjustment is performed at a vehicle factory, a dealer, or the like, it is possible to prevent erroneous angle adjustment occurring when vibration caused by contact with a vehicle, such as getting on and off the vehicle by a worker, at the time of antenna angle adjustment after attaching a radar device to the vehicle, is given to the vehicle.

What is claimed is:

1. A radar device comprising:
a housing;
a planar antenna tiltably provided with respect to the housing;
a detecting section that detects a tilt angle of the planar antenna with respect to the gravity direction;
a moving section that moves the planar antenna to adjust the tilt angle of the planar antenna; and
a storage section that stores a history of the tilt angle of the planar antenna and a tiltable range of the planar antenna with respect to the housing,
wherein the moving section moves the planar antenna by a first angle to adjust the tilt angle of the planar antenna to a reference angle if the sum of the history of the tilt angle of the planar antenna and the first angle is within the tiltable range of the planar antenna, and
wherein the moving section does not move the planar antenna by the first angle if the sum of the history of the tilt angle of the planar antenna and the first angle is beyond the tiltable range of the planar antenna.

2. The radar device as set forth in claim 1, wherein the history of the tilt angle starts from an initial value of a tilt angle of the planar antenna with respect to the housing.

3. The radar device as set forth in claim 1, wherein the detecting section includes an acceleration sensor provided in the planar antenna.

4. The radar device as set forth in claim 1, wherein the detecting section includes: a sensor provided in the housing, the sensor that detects a tilt angle of the housing with respect to the gravity direction; and a control section that detects the tilt angle of the planar antenna with respect to the gravity direction on the basis of the tilt angle of the housing and the history of the tilt angle of the planar antenna.

5. The radar device as set forth in claim 1, further comprising a control section that outputs a warning when the sum of the history of the tilt angle of the planar antenna and the first angle is beyond the tiltable range of the planar antenna.

6. The radar device as set forth in claim 1, further comprising a control section that outputs a warning when the sum of the history of the tilt angle of the planar antenna and the first angle is within the tiltable range of the planar antenna and is beyond a predetermined threshold value.

7. The radar device as set forth in claim 1, wherein the moving section includes a deceleration mechanism that decelerates rotation of a motor to convert the rotation of the motor into a driving force of the planar antenna.

8. The radar device as set forth in claim 1,
wherein when the housing is mounted on a horizontal plane, the detecting section detects an initial tilt angle of the planar antenna with respect to the gravity direction and the storage section stores the initial tilt angle,
wherein when the housing is then mounted on a vehicle, the detecting section detects a secondary tilt angle of the planar antenna with respect to the gravity direction,
wherein if the sum of the initial tilt angle and the secondary tilt angle is within the tiltable range of the planar antenna, the moving section moves the planar antenna by the secondary tilt angle to adjust the tilt angle of the planar antenna to the reference angle and the storage section stores the secondary tilt angle,
wherein if the sum of the initial tilt angle and the secondary tilt angle is beyond the tiltable range of the planar antenna, the moving section does not move the planar antenna by the secondary tilt angle,
wherein when the housing is then moved, the detecting section detects a tertiary tilt angle of the planar antenna with respect to the gravity direction,
wherein if the sum of the initial tilt angle, the secondary tilt angle and the tertiary tilt angle is within the tiltable range of the planar antenna, the moving section moves the planar antenna by the tertiary tilt angle to adjust the tilt angle of the planar antenna to the reference angle and the storage section stores the tertiary tilt angle, and
wherein if the sum of the initial tilt angle, the secondary tilt angle and the tertiary tilt angle is beyond the tiltable range of the planar antenna, the moving section does not move the planar antenna by the tertiary tilt angle.

9. A radar device comprising:
a tilt angle detecting section that detects a tilt angle of an antenna with respect to a target angle;
an adjusting section that adjusts an angle of the antenna from the tilt angle to the target angle;
a calculating section that calculates an estimation value which is a criterion for determining whether or not an adjustment from the tilt angle to the target angle is performed as planned;
a measurement value detecting section that detects a measurement value in accordance with variation in the angle of the antenna during the adjustment from the tilt angle to the target angle; and
an adjustment failure detecting section that detects a failure of the adjustment on the basis of an error between the estimation value and the measurement value.

10. The radar device as set forth in claim 9,
wherein the estimation value includes estimation angles of the antenna for every predetermined time, and
wherein the measurement value includes measurement angles of the antenna for every predetermined time.

11. The radar device as set forth in claim 9,
wherein the estimation value includes an estimation time to complete the adjustment, and
wherein the measurement value includes a measurement time to complete the adjustment.

12. The radar device as set forth in claim 9,
wherein the estimation value includes estimation angles of the antenna for every predetermined time and an estimation time to complete the adjustment,
wherein the measurement value includes measurement angles of the antenna for every predetermined time and a measurement time to complete the adjustment, and
wherein the adjustment failure detecting section detects the failure of the adjustment on the basis of an error between the estimation angles and the measurement angles for every predetermined time and an error between the estimation time and the measurement time.

13. The radar device as set forth in claim 9, further comprising a notifying section that notifies that the error exceeds a predetermined range.

14. A method for adjusting an angle of an antenna, comprising:
detecting a tilt angle of the antenna with respect to a target angle;
adjusting the angle of the antenna from the tilt angle to the target angle;
calculating an estimation value which is a criterion for determining whether or not the adjusting of the angle of the antenna from the tilt angle to the target angle is performed as planned;
detecting a measurement value in accordance with variation in the angle of the antenna during the adjusting of the angle of the antenna from the tilt angle to the target angle; and
detecting a failure of the adjusting on the basis of an error between the estimation value and the measurement value.
